(19) United States
(12) Patent Application Publication
(10) Pub. No.: US 2022/0390281 A1
(43) Pub. Date: Dec. 8, 2022

(54) PROVIDING POLARIZATION DIVERSITY AND REDUCING POLARIZATION DEPENDENT LOSS (PDL) IN A GRATING-BASED OPTICAL SPECTRUM ANALYZER (OSA)

(71) Applicant: VIAVI SOLUTIONS INC., San Jose, CA (US)

(72) Inventors: Driss TOUAHRI, Nepean (CA); Christopher Russell WAGNER, Kanata (CA)

(73) Assignee: VIAVI SOLUTIONS INC., San Jose, CA (US)

(21) Appl. No.: 17/339,690

(22) Filed: Jun. 4, 2021

(51) Int. Cl. G01J 3/45; G01J 3/02

(52) U.S. Cl. CPC G01J 3/45; G01J 3/0224; G01J 2003/1291

(57) ABSTRACT

A system for a high resolution optical spectrum analyzer (OSA) using various optical configurations to reduce polarization dependent loss (PDL) is disclosed. The system may include a birefringent element to receive an input optical beam. The birefringent element may then split the input optical beam into a first optical beam and a second optical beam. The system may also include an optical configuration, which may determine an optical beam path associated with the first optical beam and the second optical beam, transmit the first optical beam in a first direction along the optical beam path and transmit the second optical beam in a second direction along the optical beam path.

### TECHNICAL FIELD

This patent application is directed to optical measurement instrumentation for telecommunication networks, and more specifically, to providing polarization diversity and reducing polarization dependent loss (PDL) in a grating-based optical spectrum analyzer (OSA).

### BACKGROUND

Optical measurement instrumentation, such as optical spectrometers or optical spectrum analyzers (OSAs), play an important role in modern optical science. Optical spectrum analyzers (OSAs), in particular, are vital in fiber-optics and optical communication technologies. From research and development (R&D) applications to manufacturing, optical spectrum analyzers (OSAs) and other similar equipment have become essential to build and characterize a variety of fiber-optics products, such as broadband sources, optical sources and wavelength division multiplexed (WDM) systems.

### BRIEF DESCRIPTION OF DRAWINGS

Features of the present disclosure are illustrated by way of example and not limited in the following Figure(s), in which like numerals indicate like elements, in which:

FIG. 1 illustrates a system for providing high resolution optical measurements, according to an example.

FIG. 2 illustrates a configuration 200 using a birefringent element and optics in a high resolution optical spectrum analyzer (OSA), according to an example.

FIGS. 3A-3E illustrate a plurality of optical configurations 300A-E providing polarization diversity while minimizing of an insertion loss (IL) difference between multiple polarization paths, according to examples.

FIG. 4 illustrates an optical configuration 400 providing polarization diversity while minimizing of an insertion loss (IL) difference between multiple polarization paths, according to an example.

FIG. 5 illustrates a flow chart of a method for providing polarization diversity while minimizing of an insertion loss (IL) difference between multiple polarization paths, according to an example.

FIG. 6 illustrates a flow chart of a method for reducing polarization dependent loss (PDL) in an optical spectrum analyzer (OSA) system, according to an example.

### DETAILED DESCRIPTION

For simplicity and illustrative purposes, the present disclosure is described by referring mainly to examples and embodiments thereof. In the following description, numerous specific details are set forth in order to provide a thorough understanding of the present disclosure. It will be readily apparent, however, that the present disclosure may be practiced without limitation to these specific details. In other instances, some methods and structures readily understood by one of ordinary skill in the art have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

In some instances, optical spectrum analyzers (OSAs) may play an important role in fiber optics and optical communication. One application of an optical spectrum analyzer (OSAs) may be as a device. In particular, the optical spectrum analyzer (OSA) may be implemented in measuring optical signal-to-noise ratio (OSNR) associated with a device-under-test, such as a device associated with a high-speed transmission network.

In some instances, optical signal-to-noise ratio (OSNR) may be directly related to a bit-error rate associated with a device-under-test. That is, in some examples, the bit-error rate(s) may often be a key performance indicator (KPI) for a device associated with a high-speed transmission network.

Measurement accuracy of optical signal-to-noise ratio (OSNR) for an optical spectrum analyzer (OSA) may often depend on a level of polarization dependent loss (PDL) level of the optical spectrum analyzer (OSA). In some instances, polarization dependent loss (PDL) may be a loss of signal power that may vary as polarization state of a propagating wave may change. In other words, polarization dependent loss (PDL) may represent a relationship of a maximum and a minimum signal power for an optical device with respect to all polarization states. In some examples, polarization dependent loss (PDL) may be expressed as a difference between a maximum and minimum loss in decibels (dB).

As discussed further below, polarization dependent loss (PDL) of a device (e.g., a test device), such as an optical spectrum analyzer (OSA), may often be a primary (limiting) factor in reduction of accuracy associated with the device. In the case of an optical spectrum analyzer (OSA), polarization dependent loss (PDL) may often directly affect measurement accuracy of signal and noise measurements. Accordingly, minimizing polarization dependent loss (PDL) in devices, such as optical spectrum analyzers (OSAs), may be a priority and may be beneficial.

There are a number of types of optical spectrum analyzers (OSAs), including Fabry-Perot-based, interferometer-based, and swept coherent heterodyne optical spectrum analyzers (OSAs). However, one of the most common optical spectrum analyzers (OSAs) for fiber-optics applications may include diffraction grating-based optical spectrum analyzers (OSAs). These types of systems may also be commonly referred to as monochromator-based optical spectrum analyzers (OSAs), and may thus be referred to interchangeably as a “grating-based” optical spectrum analyzers (OSAs) herein. Grating-based optical signal analyzers (OSAs) may be widely used in measuring optical signal-to-noise (OSNR) levels of 40 dB or higher due to their high dynamic range.

In a monochromator-based optical spectrum analyzer (OSA), for example, a broadband light from a bright and small light source may strike a diffraction grating. When this may happen, a thin space between every two adjacent lines of the diffraction grating may become an independent “source,” which may then diffract light off into a range of wavelet angles.

In some examples, for each wavelength and each specific angle, diffracted wavelets may be generated at exactly one wavelength out of phase with one another, and may therefore “add” together. So, in these examples, light with a given wavelength may leave the diffraction grating at a specific angle.

Furthermore, in some examples, the wider an illuminated portion of a diffraction grating may be, the higher the number of diffracted wavelets there may be, and consequently the narrower the diffracted beam pattern may become. This may enable a spectral resolution of the monochromator-based optical spectrum analyzer (OSA) to be proportional to the size of the illuminated portion of the diffraction grating.

Some grating-based optical spectrum analyzers (OSAs) may include use of a “double-pass” (or “dual-pass”, “two-pass”, or “2-pass”) monochromator concept. In some examples, the double-pass monochromator based optical spectrum analyzer (OSA) may incorporate an additional optical element, such as a retroreflective element or other optical element. A technical issue associated with a double-pass monochromator based optical spectrum analyzer (OSA) may be a limited ability to generate higher resolutions. In order to achieve a higher optical resolution, a double-pass monochromator-based optical spectrum analyzer (OSA), for instance, may require large, bulky, and/or expensive optics to be added on top of or to replace already-existing optical elements. And, in some examples, even if a higher optical resolution could be achieved with these additions or replacements, any increased resolution may remain limited to only a few tens of picometers (pm).

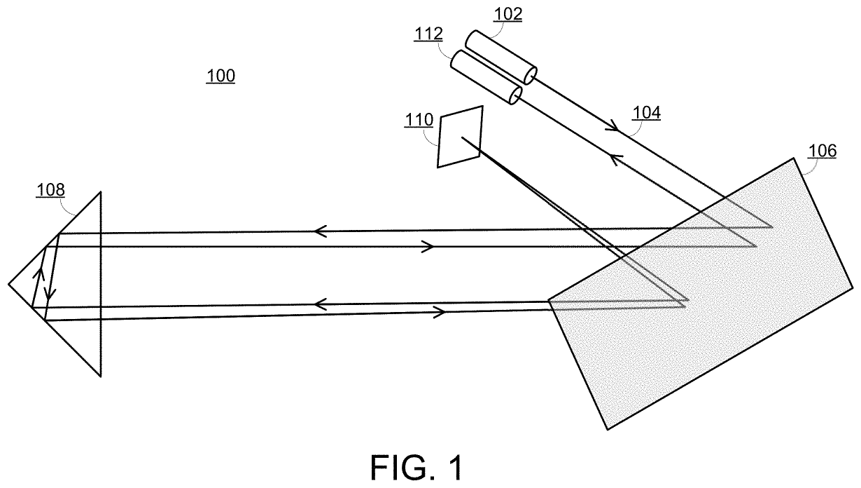

FIG. 1 illustrates a system 100 for providing higher resolution optical measurements, according to an example. In some examples, the system 100 may depict a multi-pass optical spectrum analyzer (OSA). As shown, the system 100 may be a “four-pass” (or “4-pass” or “quad-pass”) monochromator-based optical spectrum analyzer (OSA). The system 100 may include at least an input or entrance slit 102, an optical beam 104, a grating element 106, a retroreflective element 108, a mirror element 110, and an output or exit slit 112.

It should be appreciated that one or more additional optical elements may also be provided. For example, a light source (not shown) may be provided upstream of the input or entrance slit 102 to generate a broadband beam, light, or optical signal. A light detector (not shown) may also be provided downstream of the output or exit slit 112 to collect and measure the optical beam 104.

Other optical elements may also be provided as well. For instance, one or more collimators or lenses may be provided between the input slit 102 or output or exit slit 112 and the grating element 106 in order to collimate or focus the optical beam 104 as needed. For simplicity, the components and elements shown in system 100 may be helpful to illustrate the multi-pass configuration and design to achieve a high resolution optical measurements.

In some examples, the input or entrance slit 102 and output or exit slit 112 may enable or allow the optical beam 104 to pass through. Also, in some examples, the input or entrance slit 102 and output or exit slit 112 may be positioned by 1 millimeter (mm) or less apart. Other distances, dimensions, or variations may also be provided to obtain the desired optical measurement. It should be appreciated that the input or entrance slit 102 or output or exit slit 112 may be physical apertures, optical fibers, and/or other mechanisms to communicatively transmit or receive optical beams.

In some examples, the grating element 106 may be a diffraction grating. As such, the diffraction grating may be an optical component with a periodic structure that may split or diffract light into separate beams that may travel in different directions. In some examples, the diffraction grating may be a ruled, holographic, or other similar diffraction grating.

In some examples, the grating element 106 may also be configured, among other things, with various properties that include transparency (transmission amplitude diffraction grating), reflectance (reflection amplitude diffraction grating), refractive index or optical path length (phase diffraction grating), and/or direction of optical axis (optical axis diffraction grating). In some examples, the grating element 106 to be used in system 100 may be selected based on any number of factors to optimize the resolution of the optical spectrum analyzer (OSA). This may include factors, such as grating size, efficiency, incidence angle, blaze wavelength, wavelength range, stray light, resolving power, etc.

In some examples, the retroreflective element 108 may include any number of retroreflective element configurations to provide retroreflection or other similar function. In some examples, the retroreflective element 108 may be at least one of a prism reflector, a mirror, a lens, or some combination thereof. In some examples, the mirror may be a convex mirror and the lens may be a focusing lens. It should be appreciated that other retroreflective elements or configurations, or combinations of such configurations, may also be provided.

In some examples, the mirror element 110 may be a mirror or other reflective element. These may include, but not limited to, prisms, mirrors, lenses, reflectors, and/or any combination thereof. Other various optical or reflective elements may also be provided.

As shown in system 100 of FIG. 1, the optical beam 104 may travel from the input or entrance slit 102 to the grating element 106, where it may be diffracted to the retroreflective element 108, where it may be retroreflected back to the grating element 106 again, and then diffracted to the mirror element 110, at which point the optical beam 104 may be reflected back to the grating element 106 and diffracted to the retroreflective element 108, then retroreflected again to the grating element 106, where the optical beam 104 may be again diffracted and directed to the output to exit slit 112 for optical measurement (e.g., at a detector). In this way, the optical beam 104 passes through the grating element 106 four (4) times, the retroreflective element 108 twice, and the mirror element 110 once.

Because the optical beam 104 may, in some examples, pass through the grating element 106 four times between the input or entrance slit 102 and the output or exit slit 112, the multi-pass monochromator-based optical spectrum analyzer (OSA) may be referred to as a four-pass (4-pass or quad-pass) monochromator-based optical spectrum analyzer (OSA) that may be able to achieve twice the resolution of a two-pass (2-pass or dual-pass) monochromator-based optical spectrum analyzer (OSA). Moreover, in some examples, this may be accomplished without adding or replacing optical components with larger, bulkier, or more expensive ones or significantly altering the basic design of existing systems.

In some examples, after an input light beam that originates from a light source may strike the grating element 106, the optical beam 104 may be dispersed in a plane of incidence that is, for example, perpendicular to the grating lines. In these examples, for a given position of the retroreflective element 108, only one wavelength, called Lambda signal or λₛ, may trace its way back to the grating element 106. In a double-pass monochromator based optical spectrum analyzer (OSA), this lone wavelength may then be coupled back to the output or exit slit 112. Other beams with different wavelengths, however, may be diffracted at different angles, and therefore may not be normal to the retroreflective element 108. As a result, these other wavelengths may be retroreflected back towards the grating 106 at different incidence angles.

It should be appreciated that the relationship between a grating spacing and angles of an incident and diffracted beams of light may be explained by a so-called “grating equation”. So, according to the Huygens-Fresnel principle, each point on the wavefront of a propagating wave may be considered to act as a point source, and the wavefront at any subsequent point may be found by adding together contributions from each of these individual point sources. As described, gratings may be “reflective” or “transmissive” type, similar to that of a mirror or lens, respectively. A grating may have a “zero-order mode” (where m=0), in which there may be no diffraction and a ray of light may behave according to laws of reflection and refraction in a same manner as with a mirror or lens, respectively.

In some examples, a grating may be made up of a set of slits of spacing d that must be wider than the wavelength of interest to cause diffraction. Assuming an instance of a plane wave of monochromatic light of wavelength λ with normal incidence (perpendicular to the grating), each slit in the grating may act as a (quasi) point-source from which light may propagate in all directions (although this may be typically limited to a hemisphere). After light interacts with the grating, the diffracted light may be composed of a sum of interfering wave components emanating from each slit in the grating. At any given point in space through which diffracted light may pass, the path length to each slit in the grating may vary.

Moreover, since a path length may vary, so may the phases of the waves at that point from each of the slits. Thus, they may add or subtract from each other to create peaks and valleys through additive (constructive) and/or destructive interference. When the path difference between the light from adjacent slits may be equal to half the wavelength, λ/2, the waves may be out of phase, and thus cancel each other to create points of minimum intensity. Similarly, when the path difference may be λ, the phases may add together and maxima occur. The maxima may occur at angles θₘ, which satisfy the relationship:

d sin θₘ/λ=|m|,

where θₘ may represent an angle between the diffracted ray and a grating's normal vector, d may represent a distance from the center of one slit to the center of the adjacent slit, and m may represent an integer representing the propagation-mode of interest.

Thus, when light may be normally incident on the grating, the diffracted light may have maxima at angles θₘ, expressed by the following:

d sin θₘ=mλ.

If a plane wave may be incident at any arbitrary angle θᵢ the grating equation may become:

d(sin θᵢ−sin θₘ)=mλ.

When solved for the diffracted angle maxima, the equation may then be expressed as follows:

θₘ=arcsin(sin θᵢ−(mλ/d)).

It should be appreciated that these equations or expressions may assume that both sides of a grating may be in contact with a same medium (e.g., air). Light that may correspond to direct transmission (or specular reflection in the case of a reflection grating) may be called “zero order”, and may be denoted m=0. Other maxima may occur at angles represented by non-zero integers m. It should be appreciated that that m may be positive or negative, resulting in diffracted orders on both sides of the zero order beam.

Furthermore, it should be appreciated that, in some examples, this derivation of the grating equation may be based on an idealized grating element. However, a relationship between angles of the diffracted beams, grating spacing, and/or wavelength of the light may apply to any regular structure of a same spacing since phase relationship between light scattered from adjacent elements of the grating may generally remain same. In some examples, a detailed distribution of diffracted light may therefore depend on a detailed structure of the grating element(s) as well as on the number of elements in the grating structure, but it may typically provide maxima in the directions given by the grating equation.

Accordingly, a multi-pass (e.g., four-pass) monochromator-based optical spectrum analyzer (OSA) design as provided herein may enable light to be diffracted (e.g., by the same grating element) at least four times as it propagates between an input or entrance slit and an output or exit slit. So, since wavelength separation of light may be generally proportional to a number of times light interacts with the grating, a high resolution may be obtained with a single relatively small-sized grating. Moreover, the systems and methods described herein may also provide better management and control of Littrow stray light that can cause adverse effects on optical measurements.

Yet another issue associated with a monochromator-based optical spectrum analyzer (OSA) may be that grating efficiency may tend to be highly polarization dependent. For maximum grating efficiency (i.e., high optical spectrum analyzer (OSA) dynamic range and low polarization dependent loss (PDL)) input polarization may typically need to have a particular orientation with respect to a direction of a grating groove. Thus, in some examples, the systems and methods described herein may help eliminate effects of polarization dependent loss (PDL) by separating polarization eigenstates and manipulating the polarization eigenstates to give them a particular (required) orientation with respect to direction of a grating groove. In some examples and as discussed further below, this may be achieved, for example, by using birefringent optics that may employ angle-separation of the beams. Also, in some examples and as discussed further below, this may be achieved in lieu of lateral separation and used in conjunction with a depolarizer. That is, since polarization dependent loss (PDL) may be problematic in monochromator-based optical spectrum analyzers (OSAs), in order to reduce the polarization dependence of the optical spectrum analyzer (OSA), some grating-based optical spectrum analyzers (OSAs) may employ and use a depolarizer (or depolarization element) before (or in front of) the diffraction grating 106. The depolarizer may generally come in two categories: (1) free space depolarizers (e.g., wedge depolarizers, Lyot depolarizers or patterned micro-retarder arrays); or (2) pigtailed depolarizers.

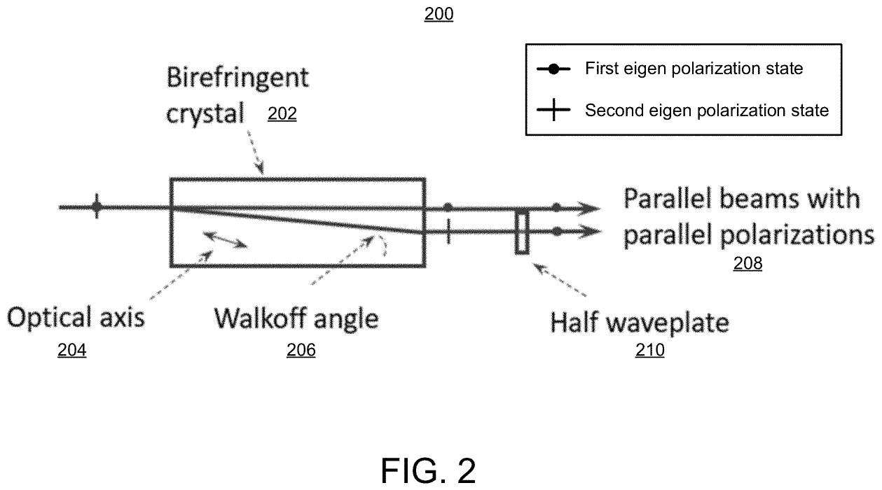

FIG. 2 illustrates a configuration 200 using a birefringent element and optics in a high resolution optical spectrum analyzer (OSA), according to an example. In some examples, to reduce grating efficiency polarization dependence over a wide wavelength range, it may be helpful to split input polarization state into two eigen polarization states and to use at least one half wave plate in an arrangement that may make two eigenstates parallel before they strike a diffraction grating, e.g., grating element 106 of system 100.

So, referring to configuration 200 of FIG. 2, one way to split an input polarization into two eigenstates in some examples may involve using a birefringent element 202 (e.g., birefringent crystal) that may be cut in such a way that the two eigenstates may propagate through the birefringent element 202 (at an optical axis 204) with a walk-off angle 206. In some examples, at the exit of the birefringent element 202, the separated eigen polarization state beams may propagate in parallel 208. In some examples, a half wave plate (or a set of half wave plates) 210 may be used to transform the respective polarization states (shown by the dot and hash to illustrate two different states) of the two separate eigen polarization state beams to an s-polarization (e.g., denoted by the dot) at the diffraction grating (not shown).

It should be appreciated that in order to spatially separate the two polarization eigenstates so that a half wave plate 210 may be inserted in their respective optical paths, the birefringent element 202 may, in some examples, generally need to have a minimum length and aperture due to a relatively small walk-off angle 206. When an optical beam may become too large however, this approach may become unreasonable and impractical, as it may require relatively bulky and costly birefringent crystals and/or wave plates. This may be similar to a problem encountered in double-pass monochromator-based optical spectrum analyzers (OSAs) requiring larger and bulkier diffraction gratings to obtain higher resolutions. In some instances, the systems and methods described herein may provide a number of various configurations to resolve these issues.

For example, a birefringent prism may split an input polarization state into two eigen polarization states, one of which may be angularly split from the other. The angular splitting of one beam may be referred to as semi-angular splitting, whereas the angular splitting of both beams may be referred to as angular splitting. In some examples, either arrangement may enable larger beam separation using a relatively smaller birefringent element or crystal. In these examples, the angularly separated beam may then be made parallel to the other by means of one or more optical arrangements comprising any number of reverse birefringent prisms or mirrors.

It should be appreciated that the polarization splitting, for example as described with respect to FIG. 2, alone may not be sufficient to eliminate or reduce effects associated with polarization. One reason for this may be a difference in insertion loss (IL) associated with distinct polarization paths traversed by optical beams in multiple polarization states.

So, in some examples, as optical beams may propagate through two individual spaced-out optical paths (e.g., as shown in FIG. 2), this may make the optical beams subject to different (i.e., unique) avenues for loss. For example, in some instances, a first polarization path may offer different (i.e., unique) imperfections (e.g., optical elements, optical aberrations) than a second polarization path. In other instances, the first polarization path may be subject to different optical aberrations than the second polarization path. As a result, these different imperfections and optical aberrations along each path may generate different insertion losses (ILs) associated with the first polarization path and the second polarization path, which may in turn lead to generation of a polarization dependent loss (PDL).

Systems and methods described herein may provide polarization diversity and reduction of polarization dependent loss (PDL) in optical devices (e.g., grating-based optical spectrum analyzers (OSAs)). In some examples, the systems and methods may provide minimization of an insertion loss (IL) difference by requiring multiple optical beams with polarization diversity of input polarization states to exchange each other's path (i.e., an “optical beam path”). As used herein “exchanging” of paths may include a first optical beam traversing substantially similar or exactly a same path as a second optical beam.

In some examples and as discussed further below, to reduce a difference in associated insertion loss (ILs), a first optical beam having a first input (eigen) polarization state and a second optical beam having a second input (eigen) polarization state may exchange each other's path(s) in opposite (i.e., reverse) directions. As used herein, an first optical beam may be transmitted in an “opposite” or “reverse” direction of a second optical beam when the first optical beam may travel toward a particular point or destination parallel to the second optical beam, which may travel away from the particular point or destination.

Also, in some examples, the first optical beam may be projected onto and returned back from an optical component (e.g., a flat mirror) along a same path that the second optical beam may travel. In some examples, by making the multiple optical beams exchange each other's path(s), this may minimize or eliminate a difference in insertion loss (IL) generated as the first optical beam and the second optical beam may propagate. Furthermore, in some examples, the systems and methods may provide polarization diversity while minimizing an polarization dependent loss (PDL) associated with implementation of multiple beams with multiple polarization states (e.g., parallel eigenstates).

In other examples, the systems and methods may enable minimization of an insertion loss (IL) difference by providing a plurality of independent mirrors (e.g., a flat mirror) for each of multiple polarization paths. In these examples, the systems and methods may associate each of the independent mirrors with one of a plurality of polarization paths. Also, in some examples, the systems and methods may enable directed adjustment(s) to the plurality of independent mirrors that may increase or decrease insertion loss (ILs) associated with one or more of the plurality of polarization paths.

So, in some examples, upon increasing or decreasing insertion loss (ILs) associated with the one or more of the multiple polarization paths, the systems and methods may provide a reduction in an associated difference in insertion loss (IL) between the plurality of polarization paths. In some examples, the plurality of polarization paths may include different eigenstates of polarization, and a polarization dependent loss (PDL) may be a difference between in insertion loss (IL) between the plurality of polarization paths. As such, in some examples, if there may be an insertion loss (IL) difference between those eigenstates of polarization, the insertion loss (IL) difference may amount to a polarization dependent loss (PDL). Accordingly, in some examples, the systems and methods described may enable greater degree(s) of freedom in reducing polarization dependent loss (PDL) during alignment and operation of optical devices.

Some advantages and benefits may be readily apparent. In some examples, insertion loss (IL) due to imperfections and/or aberrations in optical elements of an optical system may be “balanced out” between multiple polarization paths during propagation through the optical system. In some examples, this may enable minimization of a polarization dependent loss (PDL) associated with implementation of multiple polarization paths.

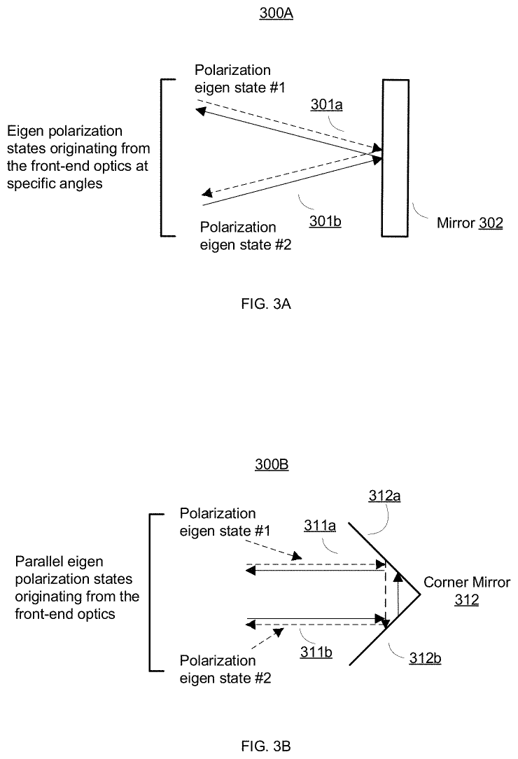

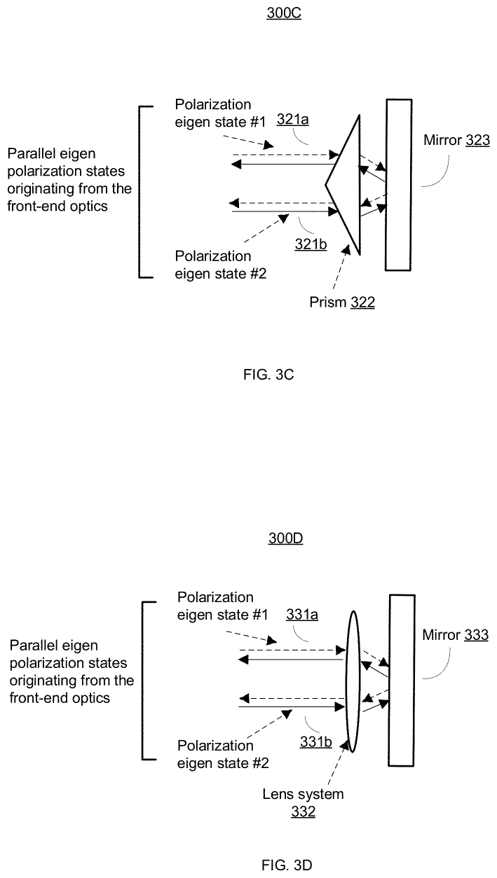

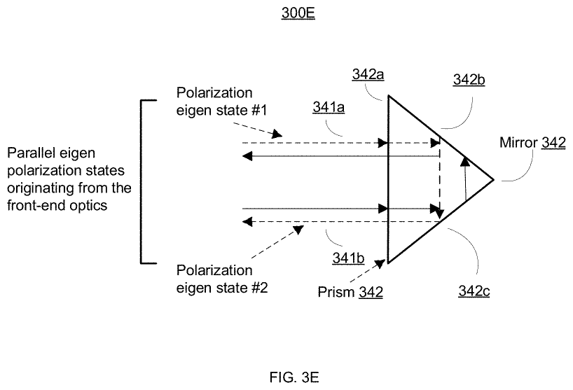

FIGS. 3A-3E illustrate a plurality of optical configurations 300A-E providing polarization diversity while minimizing an insertion loss (IL) difference between a plurality of polarization paths, according to examples. To reduce and/or eliminate a difference in insertion loss (IL) that may be seen by implementation of multiple (i.e., split), physically-separated polarization paths, the plurality of optical configurations 300A-E may enable multiple optical beams to exchange each other's paths.

By doing so, insertion loss (IL) due to various avenues for loss (e.g., imperfections in optical elements, optical aberrations, etc.) may be “balanced out” between the multiple polarization paths during propagation of a plurality of optical beams through an optical system (e.g., an optical spectrum analyzer (OSA)). It should be appreciated that the plurality of optical configurations 300A-E may be implemented and/or utilized in a variety of contexts. In some examples, the optical arrangements may be utilized in association with a multi-pass optical spectrum analyzer (OSA), as described herein. For example, in some instances, the plurality of optical configurations 300A-E may be implemented in conjunction with a higher resolution optical spectrum analyzer (OSA), such as those associated with the configurations illustrated in FIGS. 1 and 2. Indeed, it should be appreciated that the plurality of optical configurations 300A-E may provide polarization diversity while minimizing of an insertion loss (IL) difference for any device and/or configuration that may implement multiple polarization paths that may be angularly or spatially separated.

A first optical configuration 300A for achieving polarization diversity while minimizing an insertion loss (IL) difference between multiple polarization paths is shown in FIG. 3A. It should be appreciated that, in some examples, the first optical configuration 300A may be suited to operate in conjunction with a high resolution optical spectrum analyzer (OSA) implementing various angular beam separation and optics to achieve parallel eigenstates, such as the example configuration 200 illustrated in FIG. 2.

So, in the example illustrated in FIG. 3A, a first optical beam 301a may be directed in a first direction at a mirror 302, and a second optical beam 301b may be directed in a second direction at the mirror 302. In some examples, the first direction of the optical beam 301a may be a reverse direction of the second direction of the optical beam 301b. In these examples, the first optical beam 301a may be in a first eigen polarization state, and the second optical beam 301b may be in a second eigen polarization state.

In some examples, the first optical beam 301a and the second optical beam 301b may be angularly directed at the mirror 302 using an angle of incidence (not shown). So, in this example, the first optical beam 301a may be directed at the mirror 302 and may be reflected off the mirror 302 at the angle of incidence. Similarly, the second optical beam 301b may be directed the mirror 302, in a reverse direction, and may be reflected off the mirror 302 at the (same) angle of incidence.

In some examples, the first optical beam 301a and the second optical beam 301b may exchange each other's path (i.e., “optical beam path”). So, as shown in FIG. 3A, the first optical beam 301a and the second optical beam 301b may be directed along a substantially same path. In other examples, the first optical beam 301a and the second optical beam 301b may be directed along an exactly same path, wherein the path traveled by the first optical beam 301a and the second optical beam 301b may overlap. Accordingly, the first optical beam 301a and the second optical beam 301b may experience one or more avenues for loss (e.g., imperfections, aberrations, etc.) while exchanging each other's path(s), which may consequently result in a similar or equal insertion loss (IL) for the first optical beam 301a and the second optical beam 301b.

A second optical configuration 300B for achieving polarization diversity while minimizing an insertion loss (IL) difference between multiple polarization paths is shown in FIG. 3B. It should be appreciated that, in some examples, the second optical configuration 300B may be suited to operate in conjunction with a high resolution optical spectrum analyzer (OSA) implementing various angular beam separation and optics to achieve parallel eigenstates, such as the example configuration 200 illustrated in FIG. 2.

So, in some examples and as illustrated in FIG. 3B, a first optical beam 311a may be directed at a corner mirror 312 in a first direction, and a second optical beam 311b may be directed at the corner mirror 312 in a second direction that may be a reverse of the first direction. In some examples, the first optical beam 311a may be in a first eigen polarization state, and the second optical beam 311b may be in a second eigen polarization state.

That is, in some examples, the first optical beam 311a may be directed at a first surface 312a of the corner mirror 312, may reflect (e.g., perpendicularly) to a second surface 312b of the corner mirror 312, and then may reflect (e.g., perpendicularly) away from the second surface 312b of the corner mirror 312. In addition, in some examples, the second optical beam 311a may be directed at a second surface 312b of the corner mirror 312, may reflect (e.g., perpendicularly) to the first surface 312a of the corner mirror 312, and may reflect (e.g., perpendicularly) away from the first surface 312a of the corner mirror 312.

As shown in FIG. 3B, the first optical beam 311a and the second optical beam 311b may exchange each other's path (i.e., “optical beam path”). So, in some examples, the first optical beam 311a and the second optical beam 311b may be directed along a substantially same path. In other examples, the first optical beam 311a and the second optical beam 311b may be directed along an exactly same path, wherein the path traveled by the first optical beam 311a and the second optical beam 311b may overlap. Accordingly, the first optical beam 311a and the second optical beam 311b may experience one or more avenues for loss (e.g., imperfections, aberrations, etc.) while exchanging each other's path(s), which may consequently result in a similar or equal insertion loss (IL) for the first optical beam 311a and the second optical beam 311b.

A third optical configuration 300C for achieving polarization diversity while minimizing of an insertion loss (IL) difference between multiple polarization paths is shown in FIG. 3C. It should be appreciated that, in some examples, the third optical configuration 300C may be suited to operate in conjunction with a high resolution optical spectrum analyzer (OSA) implementing various angular beam separation and optics to achieve parallel eigenstates, such as the example configuration 200 illustrated in FIG. 2.

So, in some examples, and as illustrated in FIG. 3C, a first parallel optical beam 321a may be directed at a prism 322, and a second parallel optical beam 321b may be directed at the prism 322 in a second direction. In some examples, the first direction of the optical beam 321a may be a reverse direction of the second direction of the optical beam 321b. In these examples, the first optical beam 321a may be in a first eigen polarization state and the second optical beam 321b may be in a second eigen polarization state.

In some examples, the first parallel optical beam 321a may be directed at the prism 322. At this point and in some examples, while passing through the prism 322, a direction of the first parallel optical beam 321a may be refracted (i.e., deflected) a first time toward a mirror 323 at an angle of incidence (not shown). In some examples, upon being refracted toward, the first parallel optical beam 321a may reflect off the mirror 323 back toward the prism 322, where the first parallel optical beam 321a may be refracted a second time away from the prism 322. In some examples, an epoxy or air layer may separate the prism 322 and the mirror 323.

In addition, in some examples, the second parallel optical beam 321b may be directed at the prism 322. At this point and in some examples, while passing through the prism 322, a direction of the second parallel optical beam 321b may be refracted (i.e., deflected) a first time toward a mirror 323 at an angle of incidence (not shown). In some examples, upon being refracted toward, the second parallel optical beam 321b may reflect off the mirror 323 back toward the prism 322, where the second parallel optical beam 321b may be refracted a second time away from the prism 322.

In some examples, the first optical beam 321a and the second optical beam 321b may exchange each other's path (i.e., “optical beam path”). That is, the first parallel optical beam 321a may be reflected off the mirror 323 and through the prism 322 to exchange a path traversed by the second parallel optical beam 321b, and the second parallel optical beam 321b may be reflected off the mirror 323 and through the prism 322 to exchange a path traversed by the first parallel optical beam 321a. So, as shown in FIG. 3C, the first parallel beam 321a and the second parallel beam 321b may be directed along a substantially same path. In other examples, the first optical beam 321a and the second optical beam 321b may be directed along an exactly same path, wherein the path traveled by the first optical beam 321a and the second optical beam 321b may overlap. Accordingly, the first optical beam 321a and the second optical beam 321b may experience one or more same avenues of loss (e.g., imperfections, aberrations), which may consequently result in a substantially similar insertion loss (IL) for the first optical beam 321a and the second optical beam 321b.

A fourth optical configuration 300D for achieving polarization diversity while minimizing of an insertion loss (IL) difference between multiple polarization paths is shown in FIG. 3D. It should be appreciated that, in some examples, the fourth optical configuration 300D may be suited to operate in conjunction with a high resolution optical spectrum analyzer (OSA) implementing various angular beam separation and optics to achieve parallel eigenstates, such as the example configuration 200 illustrated in FIG. 2.

So, in some examples, and as illustrated in FIG. 3D, a first parallel optical beam 331a may be directed at a lens system 332, and a second parallel optical beam 331b may be directed at the lens system 332 in a second direction. In some examples, the first direction of the optical beam 331a may be a reverse direction of the second direction of the optical beam 331b. In these examples, the first optical beam 331a may be in a first eigen polarization state and the second optical beam 331b may be in a second eigen polarization state.

In some examples, the first parallel optical beam 331a may be directed at the lens system 332. At this point and in some examples, while passing through the lens system 332, a direction of the first parallel optical beam 331a may be refracted (i.e., deflected) a first time toward a mirror 333 at an angle of incidence (not shown). In some examples, upon being refracted toward, the first parallel optical beam 331a may reflect off the mirror 333 back toward the lens system 332, where the first parallel optical beam 331a may be refracted a second time away from the lens system 332. In some examples, an epoxy or air layer may separate the prism 332 and the mirror 333.

In addition, in some examples, the second parallel optical beam 331b may be directed at the lens system 332. At this point and in some examples, while passing through the lens system 332, a direction of the second parallel optical beam 331b may be refracted (i.e., deflected) a first time toward a mirror 333 at an angle of incidence (not shown). In some examples, upon being refracted toward, the second parallel optical beam 331b may reflect off the mirror 333 back toward the lens system 332, where the second parallel optical beam 331b may be refracted a second time away from the lens system 332.

In some examples, the first optical beam 331a and the second optical beam 331b may exchange each other's path (i.e., “optical beam path”). That is, the first parallel optical beam 331a may be reflected off the mirror 333 and through the lens system 332 to exchange a path traversed by the second parallel optical beam 331b, and the second parallel optical beam 331b may be reflected off the mirror 333 and through the lens system 332 to exchange a path traversed by the first parallel optical beam 331a. So, as shown in FIG. 3D, the first parallel beam 331a and the second parallel beam 331b may be directed along a substantially same path. In other examples, the first optical beam 331a and the second optical beam 331b may be directed along an exactly same path, wherein the path traveled by the first optical beam 331a and the second optical beam 331b may overlap. Accordingly, the first optical beam 331a and the second optical beam 331b may experience one or more same avenues of loss (e.g., imperfections, aberrations), which may consequently result in a substantially similar insertion loss (IL) for the first optical beam 331a and the second optical beam 331b.

A fifth optical configuration 300E for achieving polarization diversity while minimizing of an insertion loss (IL) difference between multiple polarization paths is shown in FIG. 3E. It should be appreciated that, in some examples, the fifth optical configuration 300E may be suited to operate in conjunction with a high resolution optical spectrum analyzer (OSA) implementing various angular beam separation and optics to achieve parallel eigenstates, such as the example configuration 200 illustrated in FIG. 2.

So, in some examples and as illustrated in FIG. 3E, a first optical beam 341a may be directed at a prism 342 in a first direction, and a second optical beam 341b may be directed at the prism 342 in a second direction that may be a reverse of the first direction. In these examples, the first optical beam 341a may be in a first eigen polarization state, and the second optical beam 341b may be in a second eigen polarization state.

In some examples, the first optical beam 341a may be directed at a first surface 342a of the prism 342, and may hit and reflect (e.g., perpendicularly) away from a second surface 342b of the prism 342 toward a third surface 342c of the prism 342. At this point, the first optical beam 341a may hit and reflect (e.g., perpendicularly) away from the third surface 342c of the prism 342 back toward the first surface 342a of the prism 342, where the first optical beam 341a may transmit through.

Similarly in some examples, the second optical beam 341b may be directed at the first surface 342a of the prism 342, may transmit through to the third surface 342c of the prism 342, and may reflect (e.g., perpendicularly) away from the third surface 342c of the prism 342 toward a second surface 342b of the prism 342. At this point, the second optical beam 341b may reflect (e.g., perpendicularly) away from the second surface 342b of the prism 342 back toward the first surface 342a of the prism 342, where the first optical beam 341a may transmit through.

Moreover, in some examples and as shown in FIG. 3E, the first optical beam 341a and the second optical beam 341b may exchange each other's path (i.e., “optical beam path”). That is, in some examples and as shown in FIG. 3E, the first optical beam 341a and the second optical beam 341b may be directed along a substantially same path. However, in other examples, the first optical beam 341a and the second optical beam 341b may be directed along an exactly same path, wherein the path traveled by the first optical beam 341a and the second optical beam 341b may overlap. Accordingly, the first optical beam 341a and the second optical beam 341b may experience one or more same avenues of loss (e.g., imperfections, aberrations, etc.) along the substantially same path, which may consequently result in a substantially similar insertion loss (IL) for the first optical beam 341a and the second optical beam 341b.

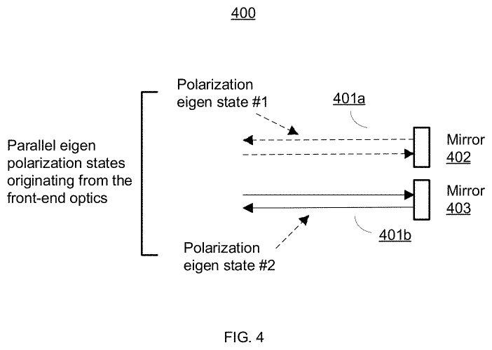

Another optical configuration 400 for minimizing of an insertion loss (IL) difference between multiple polarization paths is shown in FIG. 4. In some examples, the optical arrangement 400 may include a first mirror 402 and a second mirror 403. It should be appreciated that, in some examples, the first optical configuration 400 may be suited to operate in conjunction with a high resolution optical spectrum analyzer (OSA) implementing various angular beam separation and optics to achieve parallel eigenstates, such as the example configuration 200 illustrated in FIG. 2.

In some examples, a first parallel optical beam 401a may be directed along a first path toward the first mirror 402 and reflected back, while the second parallel optical beam 401b may be directed along a second path to the second mirror 403 and reflected back. In these examples, the first optical beam 401a may be in a first eigen polarization state, and the second optical beam 401b may be in a second eigen polarization state.

So, in some examples, as the first parallel optical beam 401a may experience a different (e.g., greater, less, etc.) insertion loss (IL) along the first path than the second parallel optical beam 401b traveling along the second path, the insertion loss (IL) difference between the two may be “corrected” by adjusting one or more of the first mirror 402 and the second mirror 403.

So, in some examples, the first mirror 402 may be realigned (i.e., adjusted) to balance an insertion loss (IL) associated with the first parallel optical beam 401a with respect to an insertion loss (IL) associated with the second parallel optical beam 401b by introducing a compensating loss with the first parallel optical beam 401a. In other examples, the second mirror 402 may be voluntarily realigned to balance an insertion loss (IL) associated with the second parallel optical beam 401b with respect to an insertion loss (IL) associated with the first parallel optical beam 401a by introducing a compensating loss with the second parallel optical beam 401b.

In some examples, to adjust a placement of a mirror (e.g., the second mirror 403), an insertion loss (IL) associated with a first mirror and an insertion loss (IL) associated with a second mirror may (first) be measured. In some examples, the insertion loss (IL) associated with a first mirror and the insertion loss (IL) associated with a second mirror may be measured via use of a detector (not shown). Based on the measurement(s), a corresponding misalignment may be determined which may “correct” to ensure that the insertion loss (IL) associated with a first mirror and an insertion loss (IL) associated with a second mirror may be substantially same or equal. Upon determining the misalignment that may be utilized, one of the first mirror 402 and the second mirror 403 may be adjusted.

As discussed further below, another approach to balance an insertion loss (IL) difference that may occur between two eigen polarization paths may be to replace a single mirror with one independent mirror for each eigen polarization state, such as the first mirror 402 and the second mirror 403. It should be appreciated that, in some examples, use of these independent mirrors may enable independent balancing of insertion loss (IL) associated with both polarization paths by voluntarily introducing insertion loss (IL) to one or more of the polarizations. Indeed, in some examples, this may result in small(er) coupling loss(es) associated with a device implementing the two eigen polarization paths and adjustment(s) of an associated polarization dependent loss (PDL).

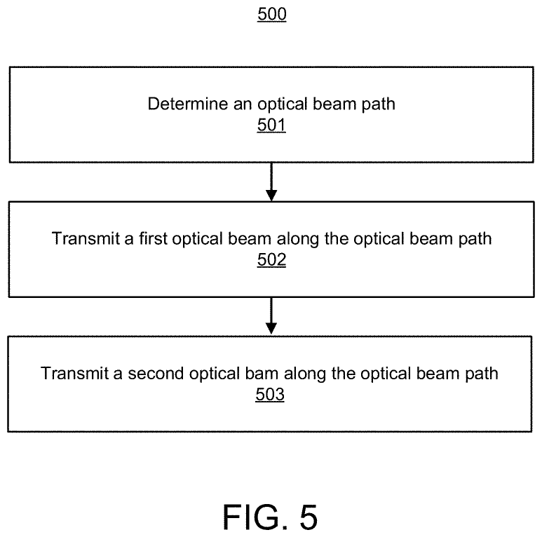

FIG. 5 illustrates a flow chart of a method for reducing polarization dependent loss (PDL) in an optical spectrum analyzer (OSA) system, according to an example. The method 500 is provided by way of example, as there may be a variety of ways to carry out the method described herein. Although the method 500 is primarily described as being performed by the system 100 of FIG. 1, the method 500 may be executed or otherwise performed by one or more processing components of another system or a combination of systems. Each block shown in FIG. 5 may further represent one or more processes, methods, or subroutines, and one or more of the blocks may include machine readable instructions stored on a non-transitory computer readable medium and executed by a processor or other type of processing circuit to perform one or more operations described herein.

At block 501, an optical beam path may be determined. In some examples, the optical beam path may be determined to enable a first optical beam having a first polarization state and a second an optical beam having a second polarization state to pass through an optical configuration associated with an optical system, similar to the system 100. In some examples, the optical configuration may include a prism and a mirror.

At block 502, the first optical beam having the first polarization state may be transmitted in a first direction along the (determined) optical beam path. So, in some examples, the first optical beam having the first polarization state may traverse the optical beam path by traveling through a prism and/or reflected off a mirror.

At block 503, the second optical beam having the second polarization state may be transmitted in a second direction along the (determined) optical beam path. In some examples, the second optical beam having the second polarization state may be transmitted in a reverse direction that the first optical beam having the first polarization state may be traversing. Moreover, in some examples, the first optical beam and the second optical beam may be directed along a substantially same path (i.e., in reverse directions). However, in other examples, the first optical beam and the second optical beam may be directed along an exactly same path (i.e., also in reverse directions), wherein the path traveled by the first optical beam and the second optical beam may overlap.

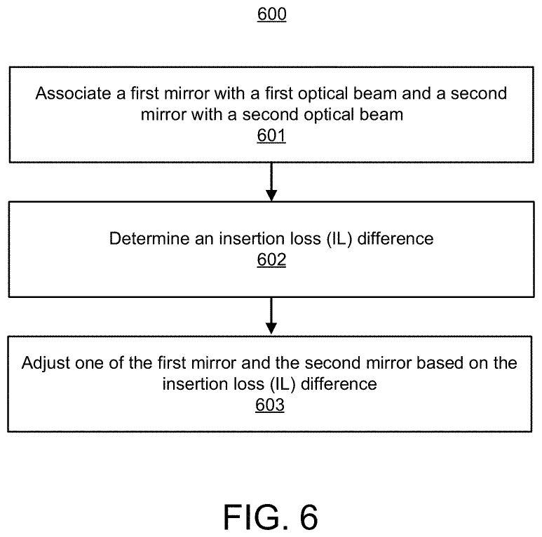

FIG. 6 illustrates a flow chart of a method for reducing polarization dependent loss (PDL) in an optical spectrum analyzer (OSA) system, according to an example. The method 600 is provided by way of example, as there may be a variety of ways to carry out the method described herein. Although the method 600 is primarily described as being performed by the system 100 of FIG. 1, the method 600 may be executed or otherwise performed by one or more processing components of another system or a combination of systems. Each block shown in FIG. 6 may further represent one or more processes, methods, or subroutines, and one or more of the blocks may include machine readable instructions stored on a non-transitory computer readable medium and executed by a processor or other type of processing circuit to perform one or more operations described herein.

At block 601, in some examples, a first mirror may be associated with a first optical beam having a first polarization state. This may include positioning the first mirror based on a reflecting of the first optical beam having the first polarization state by the first mirror. Furthermore, in some examples, a second mirror may be associated with a second optical beam having a second polarization state. This may include positioning the second mirror based on a reflecting of the second optical beam having the second polarization state by the second mirror.

At block 602, an insertion loss (IL) associated with the first optical beam having a first polarization state and an insertion loss (IL) associated with the second optical beam having a second polarization state may be measured. Moreover, in some examples, a difference between the first insertion loss (IL) and the second insertion loss (IL) may be determined as well. In some examples, the first insertion loss (IL) and the second insertion loss (IL) may be determined via use of a detector.

At block 603, in some examples, the position of the first mirror and/or the position of the second mirror may be adjusted based on the determined difference between the difference between the first insertion loss (IL) and the second insertion loss (IL). More particularly, the position of the first mirror and/or the position of the second mirror may be adjusted to minimize a difference in insertion loss (IL) between the first optical beam having a first polarization state and the second optical beam having a second polarization state.

Although described with respect to the multi-pass configuration of system 100, it should be appreciated that the systems and methods described herein may be used in at least one of a single-pass optical spectrum analyzer (OSA), multi-pass optical spectrum analyzer (OSA), narrow (or ultra-narrow) band tunable filter, an extended cavity diode laser, and/or other optical system.

Moreover, as mentioned above, there may be numerous ways to configure or position the various optical elements of the system 100, such as the grating element 106, the retrorefiective element 108, and/or the mirror 110, or other optical elements of configurations 300A-300E and 300A-300E. Although these may be adjusted to reduce or eliminate polarization dependent loss (PDL), as described herein, adjusting these and other components may also provide a more efficient or compact design for the optical path of the optical beam 104. In this way, other electrical, thermal, mechanical and/or design advantages may also be obtained.

While examples described herein are directed to configurations as shown, it should be appreciated that any of the components described or mentioned herein may be altered, changed, replaced, or modified, in size, shape, and numbers, or material, depending on application or use case, and adjusted for desired resolution or optimal measurement results.

It should be appreciated that the systems and methods described herein may minimize, reduce, and/or eliminate a difference in insertion loss (IL) or polarization dependent loss (PDL), and thereby facilitate more reliable and accurate optical measurements. It should also be appreciated that the systems and methods, as described herein, may also include or communicate with other components not shown. For example, these may include extemal processors, counters, analyzers, computing devices, and other measuring devices or systems. This may also include middleware (not shown) as well. The middleware may include software hosted by one or more servers or devices. Furthermore, it should be appreciated that some of the middleware or servers may or may not be needed to achieve functionality. Other types of servers, middleware, systems, platforms, and applications not shown may also be provided at the back-end to facilitate the features and functionalities of the testing and measurement system.

Moreover, single components may be provided as multiple components, and vice versa, to perform the functions and features described herein. For example, although one prism (or other element) may be shown in an optical configuration, two more prisms (or optical elements) may also be provided to achieve a similar result. It should be appreciated that the components of the system described herein may operate in partial or full capacity, or it may be removed entirely. It should also be appreciated that analytics and processing techniques described herein with respect to the optical measurements, for example, may also be performed partially or in full by other various components of the overall system.

It should be appreciated that data stores may also be provided to the apparatuses, systems, and methods described herein, and may include volatile and/or nonvolatile data storage that may store data and software or firmware including machine-readable instructions. The software or firmware may include subroutines or applications that perform the functions of the measurement system and/or run one or more application that utilize data from the measurement or other communicatively coupled system.

The various components, circuits, elements, components, and interfaces, may be any number of mechanical, electrical, hardware, network, or software components, circuits, elements, and interfaces that serves to facilitate communication, exchange, and analysis data between any number of or combination of equipment, protocol layers, or applications. For example, the components described herein may each include a network or communication interface to communicate with other servers, devices, components or network elements via a network or other communication protocol.

Although examples are directed to test and measurement systems, such as optical spectrum analyzers (OSAs), it should be appreciated that the systems and methods described herein may also be used in other various systems and other implementations. For example, these may include an ultra-narrow band tunable filter, an extended cavity diode laser, and/or applied stages to further increase the spectral resolution of various test and measurement systems. In fact, there may be numerous applications in optical communication networks and fiber sensor systems that could employ the systems and methods as well.

It should be appreciated that the systems and methods described herein may also be used to help provide, directly or indirectly, measurements for distance, angle, rotation, speed, position, wavelength, transmissivity, and/or other related optical measurements. For example, the systems and methods described herein may allow for a high resolution (e.g., picometer-level) optical resolution using an efficient and cost-effective design concept that also facilitates the reduction or elimination of insertion loss (IL) and/or polarization dependent loss (PDL), or other adverse effects, such as Littrow stray light.

With additional advantages that include high resolution, low number of optical elements, efficient cost, and small form factor, the systems and methods described herein may be beneficial in many original equipment manufacturer (OEM) applications, where they may be readily integrated into various and existing network equipment, fiber sensor systems, test and measurement instruments, or other systems and methods. The systems and methods described herein may provide mechanical simplicity and adaptability to small or large optical measurement devices. Ultimately, the systems and methods described herein may increase resolution, minimize or better manage adverse polarization dependent loss (PDL), and improve measurement efficiencies.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims in which all terms are meant in their broadest reasonable sense unless otherwise indicated.

1. A system, comprising:
a birefringent element to:
receive an input optical beam, and
split the input optical beam into a first optical beam and a second optical beam; and
an optical configuration to:
determine an optical beam path for the first optical beam and the second optical beam;
transmit the first optical beam in a first direction along the optical beam path; and
transmit the second optical beam in a second direction along the optical beam path to enable the second optical beam to exchange a path of the first optical beam.

2. The system of claim 1, wherein the optical configuration is further to:
determine an insertion loss (IL) difference between a first insertion loss (IL) associated with the first optical beam and a second insertion loss (IL) associated with the second optical beam.

3. The system of claim 1, wherein the second direction is a opposite of the first direction.

4. The system of claim 1, wherein the first optical beam and the second optical beam are directed substantially along the optical beam path.

5. The system of claim 1, wherein the first optical beam and the second optical beam overlap along the optical beam path.

6. The system of claim 1, wherein the optical configuration comprises a mirror, and wherein the first optical beam and the second optical beam are transmitted in a direction of the mirror.

7. The system of claim 6, wherein the first optical beam and the second optical beam reflect off a plurality of surfaces of the mirror.

8. The system of claim 1, wherein the optical configuration comprises a prism, and wherein the first optical beam and the second optical beam are transmitted in a direction of the prism.

9. The system of claim 1, wherein the optical configuration comprises a lens system, and wherein the first optical beam and the second optical beam are transmitted in a direction of the lens system.

10. The system of claim 1, wherein the system is a multi-pass optical spectrum analyzer (OSA).

11. A method for providing a configuration for reducing polarization dependent loss (PDL) and providing higher resolution optical measurements, comprising:
determining an optical beam path associated with a first optical beam and a second optical beam;
transmitting the first optical beam in a first direction along the optical beam path; and
transmitting the second optical beam in a second direction along the optical beam path to enable the second optical beam to exchange a path of the first optical beam.

12. The method of claim 11, wherein the first optical beam has a first polarization state and the second optical beam has a second polarization state.

13. The method of claim 11, wherein the second direction is a opposite of the first direction.

14. The method of claim 11, wherein the first optical beam and the second optical beam are transmitted in a direction of a mirror.

15. The method of claim 14, wherein the first optical beam and the second optical beam reflect off a plurality of surfaces of the mirror.

16. The method of claim 11, wherein the first optical beam and the second optical beam are transmitted in a direction of a prism.

17. The method of claim 11, wherein the first optical beam and the second optical beam are transmitted in a direction of a lens system.

18. A non-transitory computer-readable storage medium having an executable stored thereon, which when executed instructs a processor to perform a method as follows:
position a first mirror with respect to a first optical beam and a second mirror with respect to a second optical beam;
determine an insertion loss (IL) difference between a first insertion loss (IL) for the first optical beam and a second insertion loss (IL) for the second optical beam; and
adjust a position of one or more of the first mirror and the second mirror, wherein the adjusting is based on reducing the insertion loss (IL) difference.

19. The non-transitory computer-readable storage medium of claim 18, wherein the first optical beam has a first polarization state and the second optical beam has a second polarization state.

20. The non-transitory computer-readable storage medium of claim 19, wherein one or more of the first mirror and the second mirror is a flat mirror.
